(19) United States
(12) Patent Application Publication
(10) Pub. No.: US 2021/0243219 A1
(43) Pub. Date: Aug. 5, 2021

(54) SECURITY HANDLING SKILL MEASUREMENT SYSTEM, METHOD, AND PROGRAM

(71) Applicant: NEC Corporation, Minato-ku, Tokyo (JP)

(72) Inventor: Masaru KAWAKITA, Tokyo (JP)

(73) Assignee: NEC Corporation, Minato-ku, Tokyo (JP)

(21) Appl. No.: 16/972,177

(22) PCT Filed: May 23, 2018
(86) PCT No.: PCT/JP2018/019772

§ 371 Date: Dec. 4, 2020

(51) Int. Cl. H04L 29/06

(52) U.S. Cl. CPC H04L 63/1433

(57) ABSTRACT

A skill measurement apparatus comprises an action recording part that records a communicated content between a measuring subject whose skill in handling a cyber-attack is to be measured and a simulated cyber-attack source and a skill measurement part that evaluates the skill of the measuring subject in handling a cyber-attack on the basis of whether or not the communicated content between the measuring subject and the simulated cyber-attack source includes signature indicating a predetermined search action.

### TECHNICAL FIELD

The present invention relates to a security handling skill measurement system, skill measurement apparatus, simulated cyber-attack apparatus, skill measurement method, simulated cyber-attack method, and program.

### BACKGROUND

In recent years, cyber-attacks giving nefarious commands to ICT (Information and Communication Technology) devices and IoT (Internet of Things) devices have become a social issue.

In order to prevent damage from such cyber-attacks, ICT and IoT devices that are vulnerable should be identified, and in addition to proactive measures to properly operate a security system, an incident response after a cyber-attack is required.

Patent Literature 1 discloses a vulnerability inspection system that can inspect the vulnerability of an inspection target such as a simulation environment simulating a network or real network. According to Patent Literature 1, the vulnerability inspection system includes a vulnerability inspection planning calculator that creates a vulnerability inspection plan and a vulnerability inspection calculator that attacks the inspection target according to the created inspection plan and creates the inspection results on the basis of how the inspection target behaves against the attack.

Patent Literature 2 discloses an attack resistance evaluation system that allows even a user without expertise to evaluate network security in an actual use environment. According to Patent Literature 2, the attack resistance evaluation system comprises an image forming apparatus capable of communicating with an external device and a simulated attack execution server that performs communication by being directly or indirectly connected to the image forming apparatus via a network. Further, the image forming apparatus sends a simulated attack request including identification information of the image forming apparatus to the simulated attack execution server. The simulated attack execution server executes a simulated unauthorized access attack to the image forming apparatus in response to the simulated attack request and transmits the execution results to the image forming apparatus. Then the image forming apparatus presents the results received.

### CITATION LIST

### PATENT LITERATURE

[Patent Literature 1]

Japanese Patent Kokai Publication No. JP2002-229946A

[Patent Literature 2]

Japanese Patent Kokai Publication No. JP2018-022419A

### NON PATENT LITERATURE

[Non-Patent Literature 1]

National Institute of Standards and Technology, “Computer Security Incident Handling Guide (NIST SP 800-61 R2),” [online], [searched on Apr. 24, 2018], the Internet <URL https://nvlpubs.nist.gov/nistpubs/SpecialPublications/NIST.SP.800-61r2.pdf>

### SUMMARY

### TECHNICAL PROBLEM

The following analysis is given by the present invention. Non-Patent Literature 1 defines four phases in the incidence response life cycle: (1) preparation; (2) detection and analysis; (3) containment, eradication, and recovery; and (4) post-incident activity. In (2) detection and analysis, it is recommended that attack vectors detected from network traffic be analyzed and the results of the analysis be documented.

Further, Non-Patent Literature 1 recommends that, in order to execute the incident response described above, staff members with sufficient capabilities should be deployed for ICT/IoT devices that are likely to be targeted by cyber-attacks, and that they be trained and their skills be assessed on a regular basis (refer to “3.2.4 Incident Analysis”).

In this respect, the “inspection target” aimed at by Patent Literature 1 is a simulation environment simulating a network or a real network and does not include incident response staff. This is also the case with the invention of Patent Literature 2; the evaluation target is the image forming apparatus and the invention is not intended to evaluate a human incident response team.

It is an object of the present invention to provide a security handling skill measurement system, method, and program that can contribute to providing a method for measuring the skill of those who respond to the incidents described above.

### SOLUTION TO PROBLEM

According to a first aspect, there is provided a skill measurement apparatus comprising an action recording part that records a communicated content between a measuring subject whose skill in handling a cyber-attack is to be measured and a simulated cyber-attack source, and a skill measurement part that evaluates the skill of the measuring subject in handling a cyber-attack on the basis of whether or not the communicated content between the measurement subject and the simulated cyber-attack source includes signature indicating a predetermined search action.

According to a second aspect, there is provided a simulated cyber-attack apparatus comprising a measuring subject table that stores plurality of measuring subjects whose security handling skill is to be measured, a simulated cyber-attack part that selects a measuring subject from the measuring subject table and launches a predetermined simulated cyber-attack thereon, and a notification part that notifies a predetermined skill measurement apparatus of the selected measuring subject and a source IP (Internet Protocol) address used in the simulated cyber-attack.

According to a third aspect, there is provided a security handling skill measurement system including the above-mentioned simulated cyber-attack apparatus and the above-mentioned skill measurement apparatus.

According to a fourth aspect, there is provided a skill measurement method including a step of recording a communicated content between a measuring subject whose skill in handling a cyber-attack is to be measured and a simulated cyber-attack source, and a step of evaluating the skill of the measuring subject in handling a cyber-attack on the basis of whether or not the communicated content between the measuring subject and the simulated cyber-attack source includes signature indicating a predetermined search action. This method is associated to a particular machine, namely a skill measurement apparatus that evaluates the skill of a measuring subject in handling a cyber-attack.

According to a fifth aspect, there is provided a simulated cyber-attack method including a step of selecting a measuring subject from a measuring subject table that stores a plurality of measuring subjects whose security handling skill is to be measured and launching a predetermined simulated cyber-attack thereon, and a step of notifying a predetermined skill measurement apparatus of the selected measuring subject and a source IP address used in the simulated cyber-attack. This method is associated to a particular machine, namely a simulated cyber-attack apparatus that selects a measuring subject and launches a predetermined cyber-attack thereon.

According to a sixth aspect, there is provided a program for realizing the functions of the simulated cyber-attack apparatus and the skill measurement apparatus. Further, this program can be stored in a computer-readable (non-transitory) storage medium. In other words, the present invention can be implemented as a computer program product.

### ADVANTAGEOUS EFFECT OF INVENTION

According to the present invention, it becomes possible to measure the skill of those who respond to the incidents described above.

### BRIEF DESCRIPTION OF THE DRAWINGS

FIG. 1 is a drawing showing the configuration of an exemplary embodiment of the present invention.

FIG. 2 is a drawing illustrating the configuration of a first exemplary embodiment of the present invention.

FIG. 3 is a drawing illustrating the configuration of a simulated cyber-attack apparatus of the first exemplary embodiment according to the present invention.

FIG. 4 is a drawing showing an example of information held by a source IP address storage part of the simulated cyber-attack apparatus of the first exemplary embodiment according to the present invention.

FIG. 5 is a drawing showing an example of information held by a measuring subject storage part of the simulated cyber-attack apparatus of the first exemplary embodiment according to the present invention.

FIG. 6 is a drawing illustrating the configuration of a skill measurement apparatus of the first exemplary embodiment according to the present invention.

FIG. 7 is a drawing showing an example of information held by a packet capture log storage part of the skill measurement apparatus of the first exemplary embodiment according to the present invention.

FIG. 8 is a drawing showing an example of information held by a signature storage part of the skill measurement apparatus of the first exemplary embodiment according to the present invention.

FIG. 9 is a drawing showing an example of information held by a score table storage part of the skill measurement apparatus of the first exemplary embodiment according to the present invention.

FIG. 10 is a drawing for explaining the operation of a security handling skill measurement system of the first exemplary embodiment according to the present invention.

FIG. 11 is a flowchart showing the operation of the simulated cyber-attack apparatus of the first exemplary embodiment according to the present invention.

FIG. 12 is a flowchart showing the operation of the skill measurement apparatus of the first exemplary embodiment according to the present invention.

FIG. 13 is a drawing for explaining the operation of a skill measurement part of the first exemplary embodiment according to the present invention.

FIG. 14 is a drawing for explaining the operation of the skill measurement part of the first exemplary embodiment according to the present invention.

FIG. 15 is a drawing illustrating the configuration of a computer constituting the simulated cyber-attack apparatus or the skill measurement apparatus of the present invention.

### MODES

First, an outline of an exemplary embodiment of the present invention will be given with reference to the drawings. The drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows the main flow of a signal (data) and does not exclude bidirectionality. Further, although the input/output connection points of each block in the drawings have ports or interfaces, these are omitted.

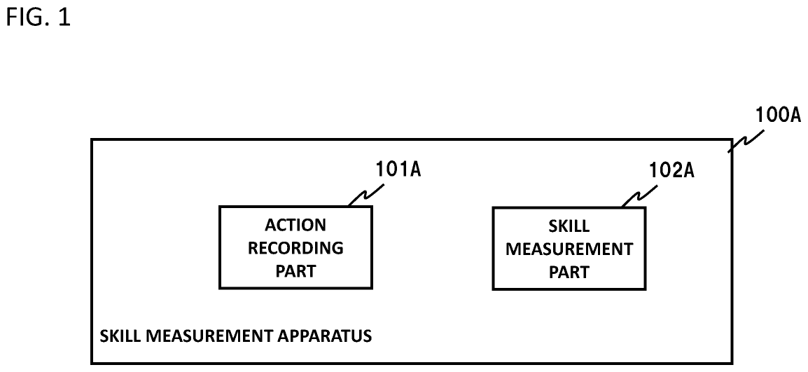

As shown in FIG. 1, the present invention in an exemplary embodiment thereof can be realized by a skill measurement apparatus 100A comprising an action recording part 101A and a skill measurement part 102A. More concretely, the action recording part 101A records the communicated content between a subject whose skill in handling a cyber-attack is to be measured and a simulated cyber-attack source. Further, the skill measurement part 102A evaluates the skill of the measuring subject in handling a cyber-attack on the basis of whether or not the communicated content between the measuring subject and the simulated cyber-attack source includes communication indicating a predetermined search action.

For instance, the action recording part 101A records the communicated content between a user A selected as a measuring subject and a simulated cyber-attack source. Then the skill measurement part 102A evaluates the degree of skill of the user A in handling a cyber-attack on the basis of whether or not the user A is taking a search action against the simulated cyber-attack source and on the basis of the content of his or her search action.

As described, according to the skill measurement apparatus 100A of the present invention, it becomes possible to accurately grasp the skill of a person who responds to incidents.

### First Exemplary Embodiment

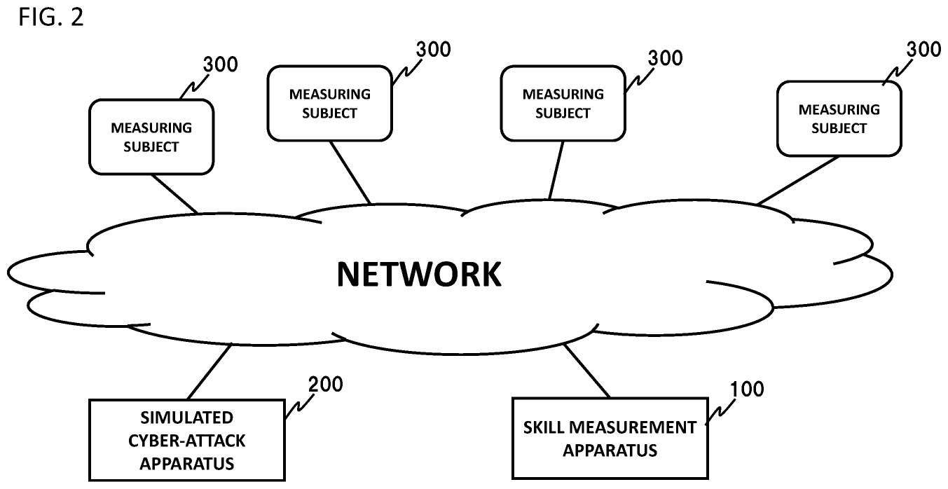

Next, a first exemplary embodiment of the present invention will be described in detail with reference to the drawings. FIG. 2 is a drawing illustrating the configuration of the first exemplary embodiment of the present invention. FIG. 2 shows a configuration in which measuring subjects 300, a simulated cyber-attack apparatus 200, and a skill measurement apparatus 100 are connected via a network.

The measuring subject 300 denotes a person who responds to a simulated cyber-attack using a computer or an apparatus having such a function (hereinafter, these are collectively referred to as “measuring subjects”). The measuring subjects include, for instance, a person in charge of incident response in a corporation, an external expert such as a security analyst, and an apparatus functioning similarly. Further, in another aspect, a potential attacker to an information system to be protected or a person or apparatus that has made a cyber-attack in the past may be selected as a measuring subject.

The skill measurement apparatus 100 operates in cooperation with the simulated cyber-attack apparatus 200 to evaluate the degree of skill of the measuring subject 300 in handling a cyber-attack. Further, the simulated cyber-attack apparatus 200 executes a simulated cyber-attack on the measuring subject 300 in order to cause the skill measurement apparatus 100 to obtain a packet capture log. A security handling skill measurement system of the present exemplary embodiment is configured to include the skill measurement apparatus 100 and the simulated cyber-attack apparatus 200.

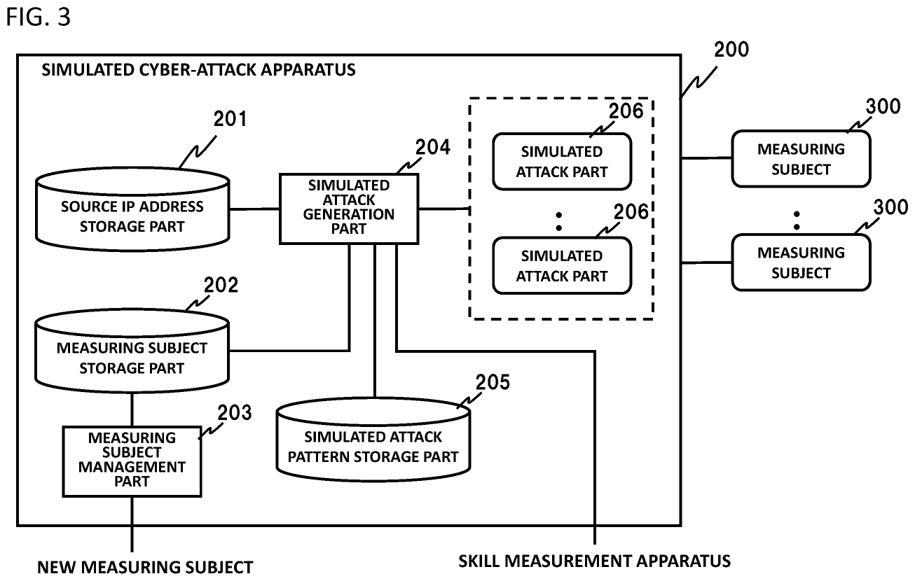

FIG. 3 is a drawing illustrating the configuration of the simulated cyber-attack apparatus 200 of the first exemplary embodiment according to the present invention. FIG. 3 shows a configuration that includes a source IP address storage part 201, a measuring subject storage part 202, a measuring subject management part 203, a simulated attack generation part 204, a simulated attack pattern storage part 205, and a simulated attack part 206 generated for each measuring subject 300.

The source IP address storage part 201 stores an IP address used as a source address when a simulated cyber-attack is performed by the simulated cyber-attack apparatus 200. A plurality of IP addresses are provided and managed so that the measuring subject 300 does not realize that a given cyber-attack is simulated.

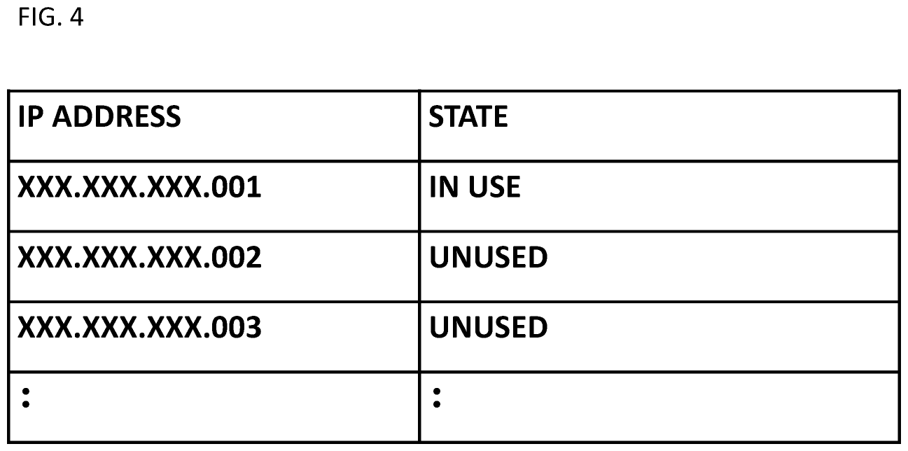

FIG. 4 is a drawing showing an example of information held by the source IP address storage part 201 of the simulated cyber-attack apparatus 200 of the present exemplary embodiment. In the example of FIG. 4, IP addresses used in simulated cyber-attacks are managed using a table that can store a plurality of entries associating the IP addresses used in simulated cyber-attacks and indicating the sources of such attacks with the state thereof. Further, in the example of FIG. 4, “state” fields show two types of states: “in use” and “unused.” The “in use” state indicates that the IP address is used in a simulated cyber-attack. The “unused” state indicates that the IP address is unused and can be issued.

The measuring subject storage part 202 stores information of the measuring subject 300, which is the target of a simulated cyber-attack by the simulated cyber-attack apparatus 200.

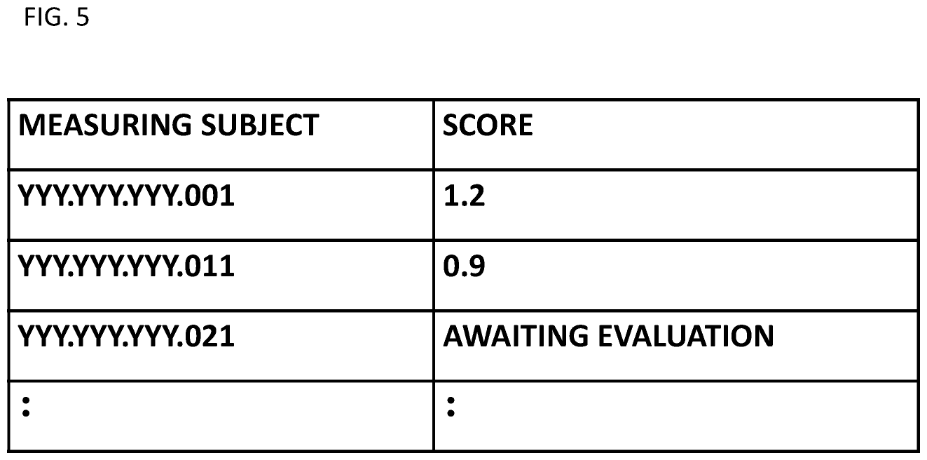

FIG. 5 is a drawing showing an example of the information held by the measuring subject storage part 202 of the simulated cyber-attack apparatus 200 of the present exemplary embodiment. In the example of FIG. 5, the measuring subjects 300 are managed using a table that can store a plurality of entries associating the IP addresses of the measuring subjects with the score information thereof. The measuring subjects 300 are managed using their IP addresses in the example of FIG. 5, however, the domain names of the measuring subjects may be additionally used.

Further, a “score” field in FIG. 5 stores an evaluation value of the skill of a given measuring subject in handling a cyber-attack. The presence or absence of this value makes it possible to identify whether or not a simulated cyber-attack has already been carried out on a measurement target 300. As a matter of course, instead of the “score,” a flag may be provided to identify whether or not a simulated cyber-attack has already been executed on a measurement target 300.

The measuring subject management part 203 receives a new measuring subject and registers a new entry showing “awaiting evaluation” in the “score” field thereof in the measuring subject storage part 202. For instance, when a new security analyst joins, this security analyst is added as a new measuring subject. Further, in another aspect, when information on a potential attacker or someone who has made a cyber-attack in the past is provided, he or she may be added as a new measuring subject.

The simulated attack pattern storage part 205 stores a pattern of a simulated cyber-attack on the measuring subject 300. For instance, this simulated cyber-attack pattern can be created using various attack tools used to evaluate the performance of an IDS (Intrusion Detection System). Stick, snot, IDSwakeup, etc. are known as such attack tools, but other attack tools can also be used.

The simulated attack generation part 204 generates a simulated attack part 206 at a predetermined timing and carries out a simulated cyber-attack on a measuring subject. More concretely, the simulated attack generation part 204 selects a measuring subject 330 and an unused source IP address from the measuring subject storage part 202 and the source IP address storage part 201, respectively. Then the simulated attack generation part 204 reads a simulated attack pattern from the simulated attack pattern storage part 205 to configure a simulated attack part 206. When carrying out a simulated cyber-attack, the simulated attack generation part 204 notifies the skill measurement apparatus 100 of the set of the source IP address used in the attack and the measuring subject 300.

The simulated attack part 206 uses the combination of the measuring subject 300 and the IP address selected by the simulated attack generation part 204 as the destination and the source, respectively, and launches an attack according to the specified simulated attack pattern. More concretely, the simulated attack part 206 generates a simulated cyber-attack packet having the specified source IP address as the source and the specified measuring subject 300 as the destination and transmits the generated packet to the measuring subject 300.

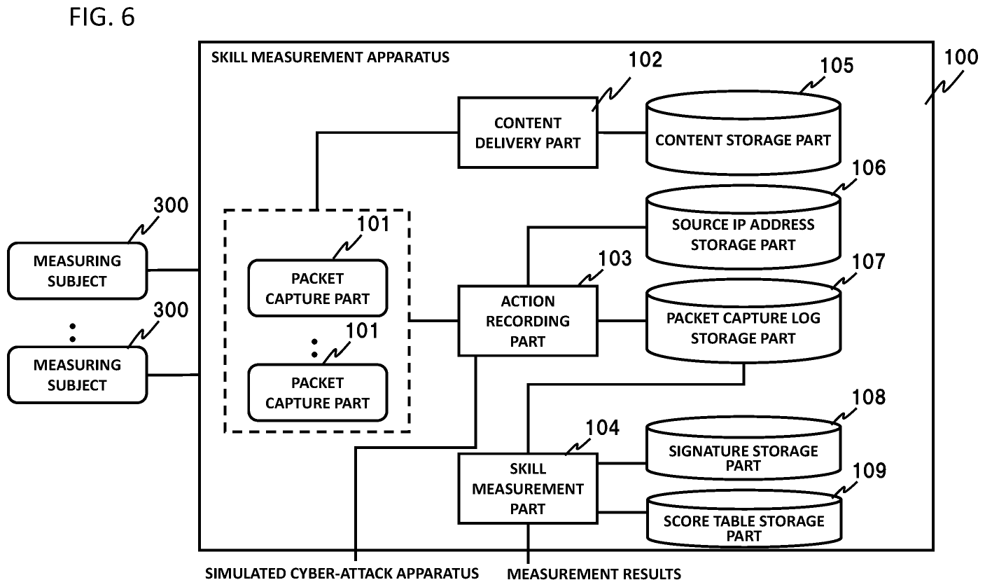

Next, the configuration of the skill measurement apparatus 100 that operates in cooperation with the simulated cyber-attack apparatus 200 will be described in detail with reference to the drawings. FIG. 6 is a drawing illustrating the configuration of the skill measurement apparatus 100 of the first exemplary embodiment according to the present invention. FIG. 6 shows a configuration that comprises packet capture parts 101, an action recording part 103, a source IP address storage part 106, a packet capture log storage part 107, a skill measurement part 104, a signature storage part 108, and a score table storage part 109. Further, the skill measurement apparatus 100 comprises a content delivery part 102 for presenting content that prompts the measuring subject 300 to perform a search action, and a content storage part 105.

As the source IP address storage part 201 of the simulated cyber-attack apparatus 200, the source IP address storage part 106 stores a source IP address used in a simulated cyber-attack.

When receiving a source IP address used in a simulated cyber-attack from the simulated cyber-attack apparatus 200, the action recording part 103 updates the state of the corresponding source IP address in the source IP address storage part 106 to “in use.” Further, the action recording part 103 generates a packet capture part 101 that captures the communication between this source IP address and the measuring subject 300.

The packet capture part 101 is created in response to an attack by the simulated attack part 206, captures the communication between the specified source IP address and the measuring subject 300, and sends the captured communication to the action recording part 103 and the content delivery part 102.

The action recording part 103 saves the packet capture data sent by the packet capture part 101 in the packet capture log storage part 107.

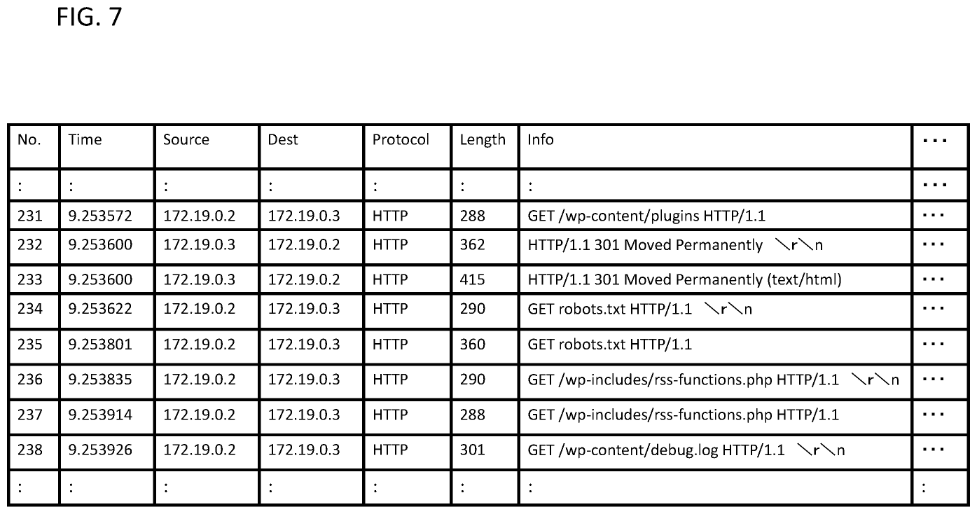

The packet capture log storage part 107 stores the packet capture data exchanged between the source IP address and the measuring subject 300. FIG. 7 is a drawing showing an example of the information held by the packet capture log storage part 107 of the skill measurement apparatus according to the exemplary embodiment. Here, for instance, let's assume that the IP address of the measuring subject 300 is 172.19.0.2 and the source IP address is 172.19.0.3. Then, data in No. 231 and in No. 234 to 238 in FIG. 7 indicate request messages transmitted from the measuring subject 300 to the source IP address. Out of these, search actions are the subject of the skill evaluation described below.

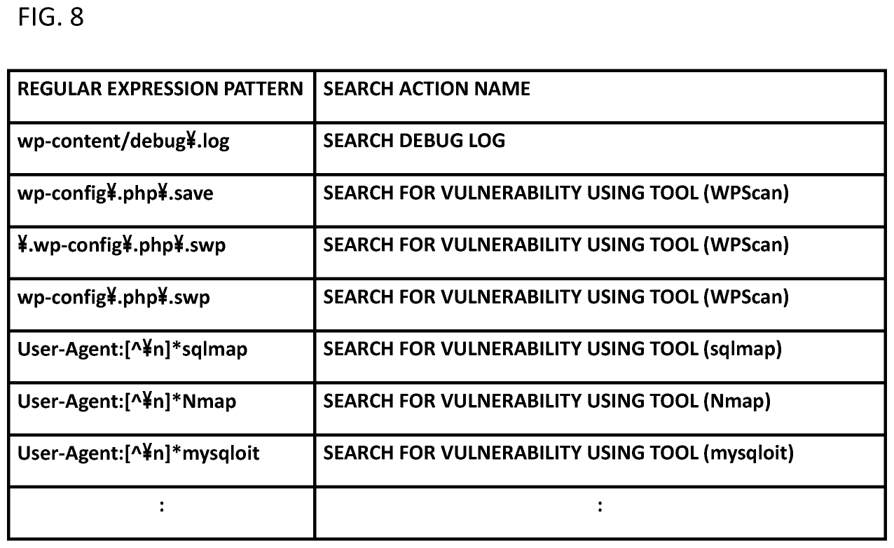

The signature storage part 108 stores a signature in which communication content indicating a search action that results in an added point in the skill evaluation is represented by a regular expression. FIG. 8 is a drawing showing an example of the information held by the signature storage part 108. The example of FIG. 8 uses a table (corresponding to a second table) storing a signature represented by a regular expression for each of several types of search actions.

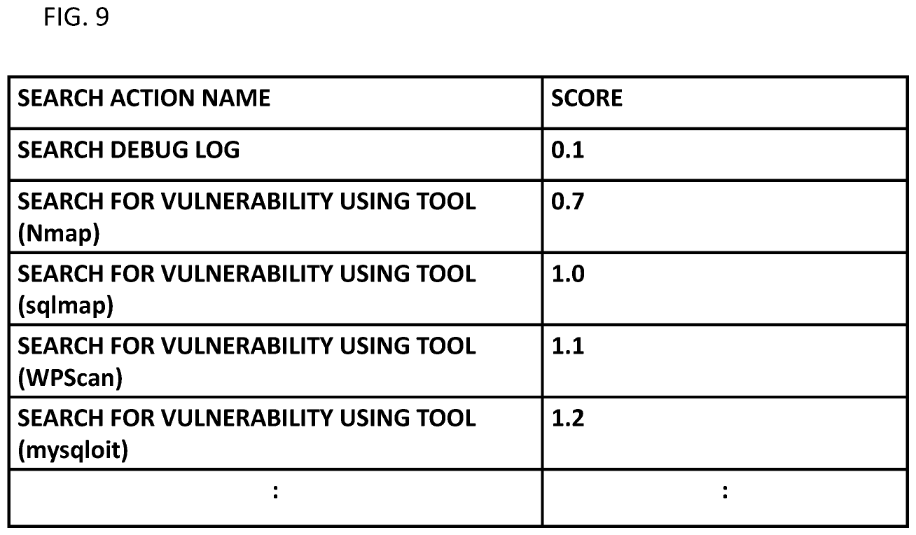

The score table storage part 109 stores a score table that determines the added scores of each type of the search actions in the skill evaluation. FIG. 9 is a drawing showing an example of the information held by the score table storage part 109. In a more preferred mode of the present invention, it is preferable that the scores be set higher for more advanced search actions.

The skill measurement part 104 identifies communication content indicating a search action by collating the packet capture log recorded in the packet capture log storage part 107 with the signatures stored in the signature storage part 108. Further, the skill measurement part 104 adds up the score of each search action referring to the score table stored in the score table storage part 109 and calculates the evaluation value representing the skill of the measuring subject 300 in handling a cyber-attack.

The content storage part 105 stores simulated content transmitted to the measuring subject 300 when the measuring subject 300 requests content from the simulated cyber-attack source at the port number that provides a predetermined service. For instance, as content returned in response to a content request using HTTP (Hypertext Transfer Protocol), a set of files such as html, jpeg, gif, and torrent is prepared. As a matter of course, it is preferable that the simulated content be prepared according to the expected service (port number).

Then the content delivery part 102 determines whether or not the measuring subject 300 has requested content from the simulated cyber-attack source at the predetermined port number on the basis of the packet capture data transmitted by the packet capture part 101. The port number here may be 80 generally used for HTTP or 443 generally used for HTTPS. It goes without saying that other port numbers managed by the Internet Assigned Numbers Authority (IANA) may be added as determination targets.

When the measuring subject 300 is determined to have requested content at the predetermined port number, the content delivery part 102 takes out simulated content and transmits it to the measuring subject 300. It is preferred that this simulated content prompt the measuring subject 300 to take a further search action. Such simulated content includes a blog (weblog) created by software called WordPress and a Wiki page that allows a viewer to update the page.

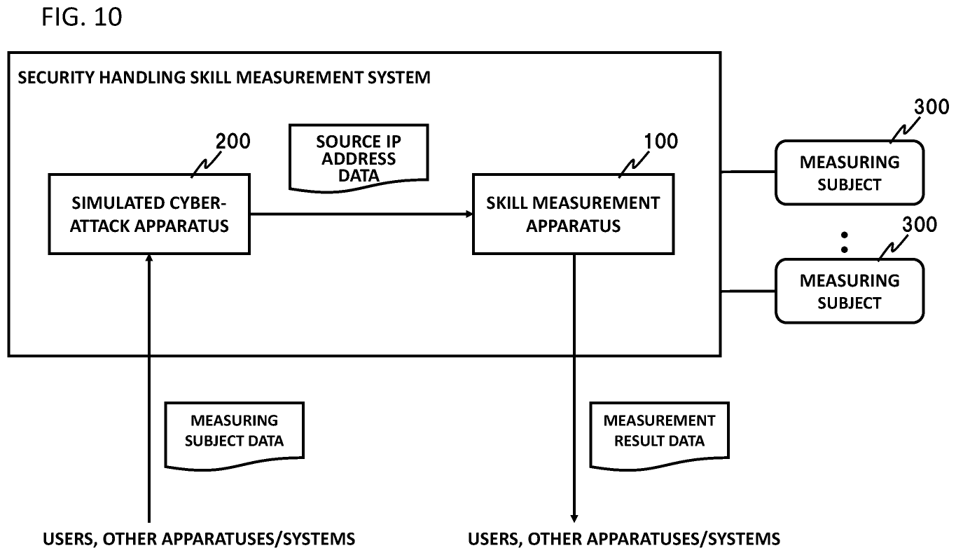

Next, the operation of the present exemplary embodiment will be described in detail with reference to the drawings. First, the operation of the entire security handling skill measurement system configured by combining the simulated cyber-attack apparatus 200 and the skill measurement apparatus 100 will be described using FIG. 10.

As shown in FIG. 10, data relating to the measuring subject 300 is supplied to the simulated cyber-attack apparatus 200 at a predetermined occasion (measuring subject data). The simulated cyber-attack apparatus 200 selects a measuring subject at a predetermined occasion and carries out a simulated cyber-attack on the measuring subject 300 using a fake source IP address. Simultaneously, the simulated cyber-attack apparatus 200 transmits a combination of the source IP address used in the simulated cyber-attack and the measuring subject 300 to the skill measurement apparatus 100 (source IP address data). The skill measurement apparatus 100 captures the communication identified by the combination of the source IP address and the measuring subject 300 and evaluates the skill on the basis of whether or not a search action is taken (measurement result data).

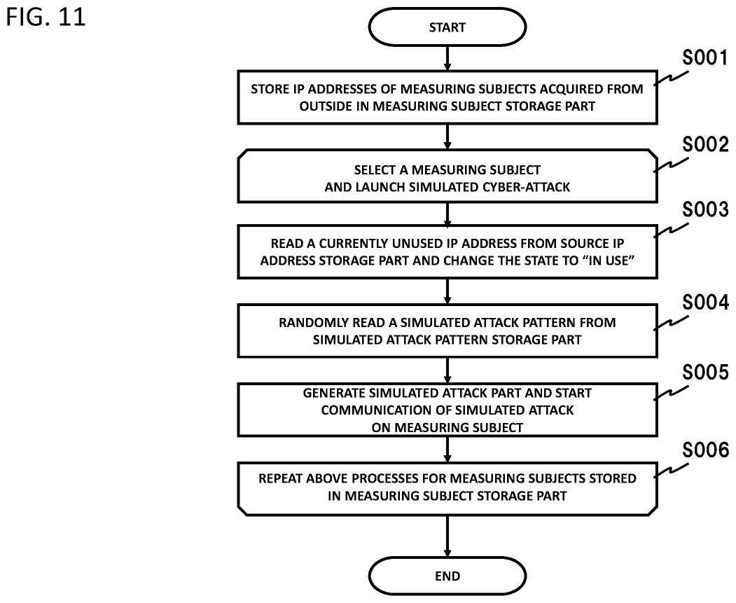

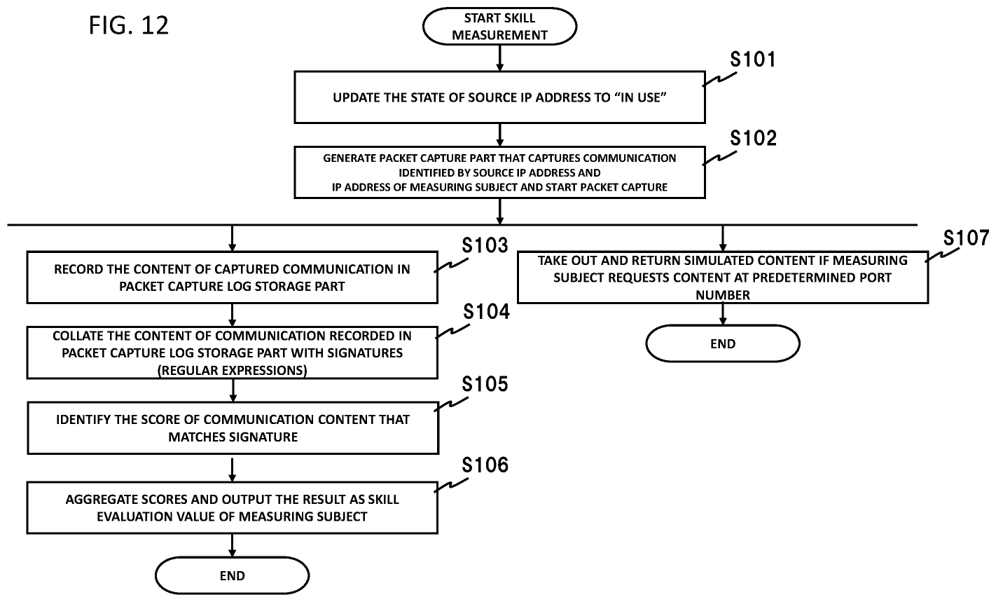

Next, the operation of the simulated cyber-attack apparatus 200 and the skill measurement apparatus 100 will be described with reference to FIGS. 11 and 12. FIG. 11 is a flowchart showing the operation of the simulated cyber-attack apparatus 200 of the first exemplary embodiment according to the present invention. With reference to FIG. 11, the simulated cyber-attack apparatus 200 first stores the IP addresses of measuring subjects acquired from outside in the measuring subject storage part 202 (step S001).

Next, the simulated cyber-attack apparatus 200 selects a measuring subject from the ones stored in the measuring subject storage part 202 and launches a simulated cyber-attack (step S002). The simulated cyber-attack apparatus 200 first reads a currently unused IP address from the source IP address storage part 201 and change the state thereof to a “in use” state (step S003).

Next, the simulated cyber-attack apparatus 200 randomly reads a simulated attack pattern from the simulated attack pattern storage part 205 (step S004).

Next, the simulated cyber-attack apparatus 200 generates a simulated attack part 206 and starts communication of a simulated attack on the measuring subject (step S005). The simulated cyber-attack apparatus 200 repeatedly performs the processes of the steps S002 to S005 for the measuring subjects stored in the measuring subject storage part 202 (step S006).

Next, the operation of the skill measurement apparatus 100 will be described. FIG. 12 is a flowchart showing the operation of the skill measurement apparatus 100 of the first exemplary embodiment according to the present invention. With reference to FIG. 12, out of the source IP addresses stored in the measuring subject storage part 202, the skill measurement apparatus 100 first updates the state of a source IP address notified by the simulated cyber-attack apparatus 200 to “in use” (step S101).

The skill measurement apparatus 100 generates a packet capture part that captures communication identified by the source IP address and the IP address of the measuring subject 300, and starts packet capture (step S102).

Thereafter the skill measurement apparatus 100 records the content of the captured communication in the packet capture log storage part 107 (step S103).

Next, the skill measurement apparatus 100 collates the content of the communication recorded in the packet capture log storage part 107 with signatures stored in the signature storage part 108 (step S104).

Next, the skill measurement apparatus 100 refers to the score table of the score table storage part 109 and identifies the score of communication content indicating a search action that matches a signature (step S105).

Next, the skill measurement apparatus 100 aggregates the scores of communication content indicating search actions and outputs the result as a skill evaluation value representing the skill of the measuring subject 300 (step S106).

Simultaneously with the skill evaluation, the skill measurement apparatus 100 takes out simulated content from the content storage part 105 and transmits it to the measuring subject 300 if the measuring subject 300 requests content provided at a predetermined port number (step S107).

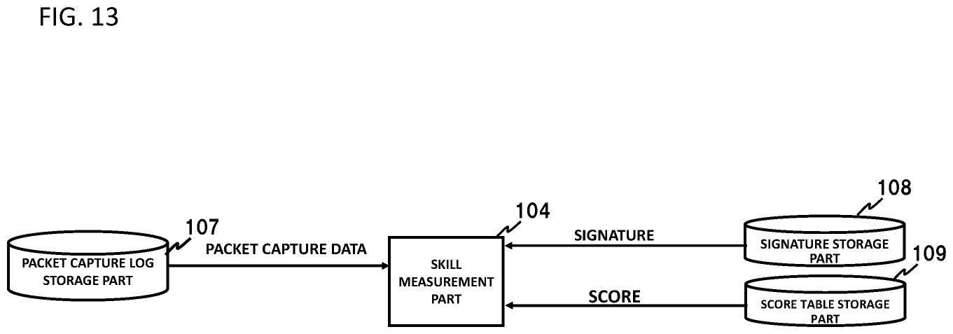

Next, the operation of the skill measurement apparatus 100 in the steps S104 to S106 will be further described in detail. FIG. 13 is a drawing for explaining the operation of the skill measurement part 104 of the skill measurement apparatus 100. As shown in FIG. 13, the skill measurement part 104 calculates an evaluation value that represents the skill of the measuring subject using packet capture data stored in the packet capture log storage part 107, a signature, and a score

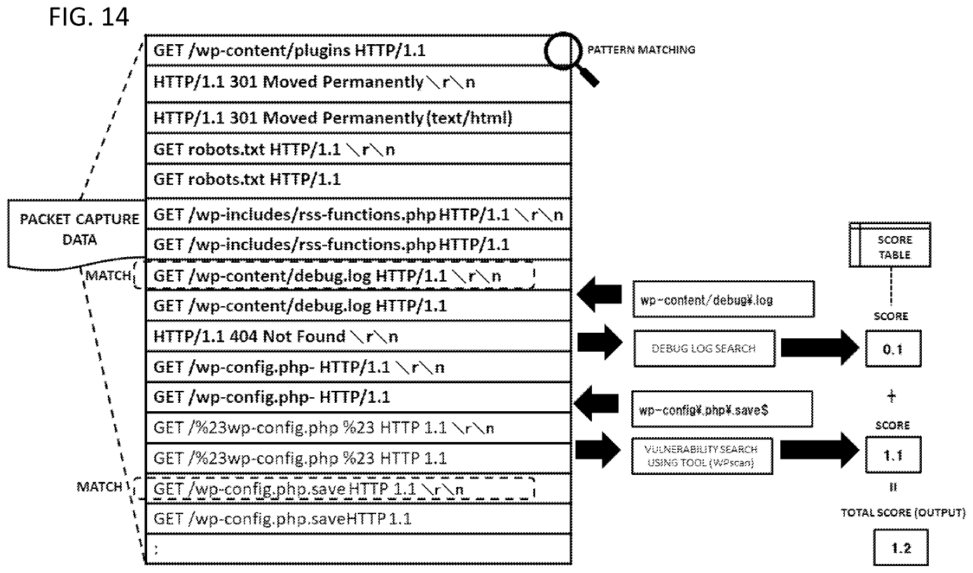

For instance, let's assume that packet capture data shown on the left side of FIG. 14 has been acquired. The skill measurement part 104 performs pattern matching between the packet capture data and the signatures shown in FIG. 8. In the example of FIG. 14, the eighth line from the top “GET /wp-content/debug.log HTTP/1.1 \r\n” matches the signature “wp-content/debug.log” indicating an action to search the debug log. At this time, the skill measurement part 104 identifies the score 0.1 corresponding to the debug log search action in the score table shown in FIG. 9. Similarly, the fifteenth line from the top “GET /wp-config.php.save HTTP/1.1 \r\n” matches the signature “wp—config¥.php¥.save$” indicating an action to search for vulnerability using a tool (WPscan). At this time, the skill measurement part 104 identifies the score 1.1 corresponding to the action to search for vulnerability using a tool (WPscan) in the score table shown in FIG. 9. If the pattern matching between the packet capture data and the signatures is completed at this point, the total score indicating the skill of the measuring subject will be 1.2. Note that the score points and weighting described above are merely examples, and for instance, the skill required for an average security analyst may be set to 100 and scores for search actions may be set on the basis thereof.

As described above, according to the present exemplary embodiment, it becomes possible to measure the analytical skill of a security analyst or security apparatus deployed for ICT/IoT devices that are likely to be targeted by cyber-attacks.

Further, according to the exemplary embodiment described above, a plurality of source IP addresses are provided and used so that it is difficult to detect that a cyber-attack is simulated. As a result, it is possible to minimize the possibility that a security analyst will stop handling the incident by blocking the communication from a simulated cyber-attack because the IP address is known due to external information sharing.

Further, according to the exemplary embodiment described above, simulated content is returned when it is determined that the measuring subject 300 has requested content at a predetermined port number. As a result, it is possible to prompt the measuring subject 300 to take a further search action and to evaluate whether or not a measuring subject with a certain level of skill has more advanced skills.

Further, according to the exemplary embodiment described above, it becomes possible to measure the skill of a person in charge of incident response in a corporation, an external expert such as a security analyst, and an apparatus functioning similarly. Further, according to the exemplary embodiment described above, a potential attacker to an information system to be protected or a person or apparatus that has made a cyber-attack in the past may be added as a measuring subject. As a result, it becomes possible to evaluate the skill of these persons or apparatuses and use the results for security measures to prevent incidents.

While each exemplary embodiment of the present invention has been described, it is to be understood that the present invention is not limited to the exemplary embodiment above and that further modifications, replacements, and adjustments may be added without departing from the basic technical concept of the present invention. For instance, the network configuration, the configuration of each element, and the expression of each message shown in each drawing are examples to facilitate understanding of the present invention and are not limited to the configurations shown in the drawings. In the following description, “A and/or B” means at least one of A and B. Further, although the input/output connection points of each block in the drawings have ports or interfaces, these are omitted. In the exemplary embodiment described above, the skill measurement apparatus 100 comprises the function of transmitting simulated content, however, for instance, a separate apparatus may realize the simulated content transmitting function. Further, in the exemplary embodiment described above, the skill measurement apparatus 100 and the simulated cyber-attack apparatus 200 are provided as separate apparatuses, however, a configuration in which the skill measurement apparatus 100 and the simulated cyber-attack apparatus 200 are integrated may also be employed.

Further, the exemplary embodiment described above assumes that the measuring subjects are primarily persons, however, the present invention can be applied to the evaluation of the performance of various security apparatuses supposed to perform the same search actions as a security analyst utilizing AI (Artificial Intelligence).

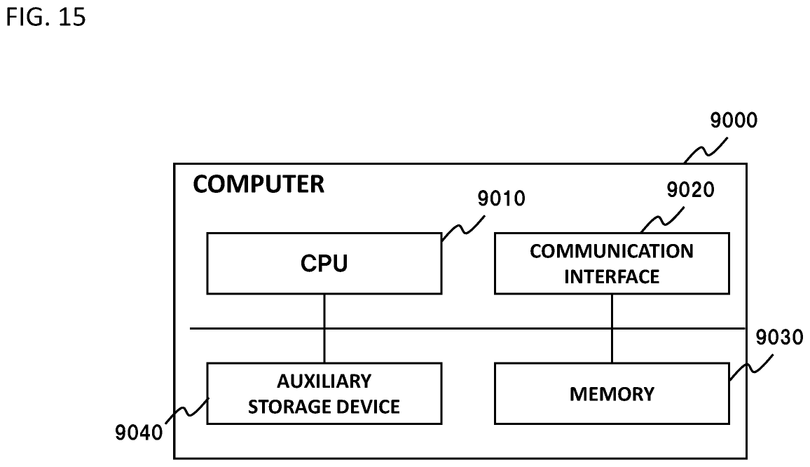

Further, the procedure described in the exemplary embodiment above can be realized by a program that causes a computer (9000 in FIG. 15) functioning as the simulated cyber-attack apparatus 200 and the skill measurement apparatus 100 to realize the functions thereof. Such a computer is illustrated in a configuration in FIG. 15 comprising a CPU (Central Processing Unit) 9010, a communication interface 9020, a memory 9030, and an auxiliary storage device 9040. In other words, the CPU 9010 in FIG. 15 executes an action recording program or skill evaluation program to perform a process of updating each calculation parameter held by the auxiliary storage device 9040.

In other words, each part (processing means, function) of the simulated cyber-attack apparatus and the skill measurement apparatus described in the exemplary embodiment above can be realized by a computer program that causes a processor in these apparatuses to execute each process described above using the hardware thereof.

Finally, preferred modes of the present invention are summarized.

### [Mode 1]

(Refer to the skill measurement apparatus according to the first aspect.)

### [Mode 2]

The skill measurement part of the skill measurement apparatus may be configured to evaluate the skill of the measuring subject in handling a cyber-attack by referring to a table that determines a score corresponding to each type of the search action and adding up the scores of search actions taken by the measuring subject.

### [Mode 3]

It is preferred that the skill measurement part of the skill measurement apparatus comprise a second table for identifying the type of a search action taken by the measuring subject from a message included in the communication.

### [Mode 4]

It is preferred that the skill measurement apparatus further comprise a content delivery part that transmits predetermined simulated content to the measuring subject when the measuring subject requests content from the simulated cyber-attack source at a predetermined port number.

### [Mode 5]

It is preferred that the simulated content be content that prompts the measuring subject to take a search action.

### [Mode 6]

The action recording part of the skill measurement apparatus may be configured to receive the measuring subject whose skill in handling a cyber-attack is to be measured and an IP address representing the simulated cyber-attack source from a predetermined simulated cyber-attack apparatus.

### [Mode 7]

(Refer to the simulated cyber-attack apparatus according to the second aspect.)

### [Mode 8]

The simulated cyber-attack part of the simulated cyber-attack apparatus may be configured to select a source IP address used in the simulated cyber-attack from IP addresses prepared in advance and use the selected IP address.

### [Mode 9]

(Refer to the security handling skill measurement system according to the third aspect.)

### [Mode 10]

(Refer to the skill measurement method according to the fourth aspect.)

### [Mode 11]

(Refer to the simulated cyber-attack method according to the fifth aspect.)

### [Mode 12]

(Refer to the program according to the sixth aspect.)

Further, similarly to Modes 1 and 2, Modes 9 to 12 can be developed into Modes 2 to 6 and Mode 8.

Further, each disclosure of Patent Literatures and Non-Patent Literature cited above is incorporated herein in its entirety by reference thereto. It is to be noted that it is possible to modify or adjust the exemplary embodiments or examples within the whole disclosure of the present invention (including the Claims) and based on the basic technical concept thereof. Further, it is possible to variously combine or select (or partially delete) a wide variety of the disclosed elements (including the individual elements of the individual claims, the individual elements of the individual exemplary embodiments or examples, and the individual elements of the individual figures) within the scope of the disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof.

### REFERENCE SIGNS LIST

100, 100A: skill measurement apparatus
101: packet capture part
101A, 103: action recording part
102: content delivery part
102A, 104: skill measurement part
105: content storage part
106: source IP address storage part
107: packet capture log storage part
108: signature storage part
109: score table storage part
200: simulated cyber-attack apparatus
201: source IP address storage part
202: measuring subject storage part
203: measuring subject management part
204: simulated attack generation part
205: simulated attack pattern storage part
206: simulated attack part
300: measuring subject
9000: computer

### 9010: CPU

9020: communication interface
9030: memory
9040: auxiliary storage device

What is claimed is:

1. A skill measurement apparatus comprising:
at least a processor; and
a memory in circuit communication with the processor,
wherein the processor is configured to execute program instructions stored in the memory to implement:
an action recording part that records a communicated content between a measuring subject whose skill in handling a cyber-attack is to be measured and a simulated cyber-attack source; and
a skill measurement part that evaluates the skill of the measuring subject in handling the cyber-attack on the basis of whether or not the communicated content between the measuring subject and the simulated cyber-attack source includes signature indicating a predetermined search action.

2. The skill measurement apparatus according to claim 1, wherein
the skill measurement part evaluates the skill of the measuring subject in handling the cyber-attack by referring to a table that determines a score corresponding to each type of the search action and adding up scores of the search action taken by the measuring subject.

3. The skill measurement apparatus according to claim 2, wherein
the skill measurement part comprises a second table for identifying the type of the search action taken by the measuring subject from a message included in the communication.

4. The skill measurement apparatus according to claim 1, wherein the processor is configured to execute the program instructions stored in the memory to implement:
a content delivery part that transmits predetermined simulated content to the measuring subject when the measuring subject requests content from the simulated cyber-attack source at a predetermined port number.

5. The skill measurement apparatus according to claim 4, wherein the predetermined simulated content prompts the measuring subject to take a search action.

6. The skill measurement apparatus according to claim 1 wherein the action recording part receives the measuring subject whose skill in handling the cyber-attack is to be measured and an IP address representing the simulated cyber-attack source from a predetermined simulated cyber-attack apparatus.

7. A simulated cyber-attack apparatus comprising:
at least a processor; and
a memory in circuit communication with the processor,
wherein the processor is configured to execute program instructions stored in the memory to implement:
a measuring subject table that stores a plurality of measuring subjects whose skill in security handling is to be measured;
a simulated cyber-attack part that selects a measuring subject from the measuring subject table and launches a predetermined simulated cyber-attack thereon; and
a notification part that notifies a predetermined skill measurement apparatus of the selected measuring subject and a source IP address used in the simulated cyber-attack.

8. The simulated cyber-attack apparatus according to claim 7, wherein the simulated cyber-attack part selects a source IP address used in the simulated cyber-attack from IP addresses prepared in advance and uses the selected IP address.

9. A security handling skill measurement system including:
a simulated cyber-attack apparatus that comprises a measuring subject table that stores a plurality of measuring subjects whose security handling skill is to be measured, a simulated cyber-attack part that selects a measuring subject from the measuring subject table and launches a predetermined simulated cyber-attack thereon, and a notification part that notifies a predetermined skill measurement apparatus of the selected measuring subject and a source IP address used in the simulated cyber-attack; and
a skill measurement apparatus that comprises an action recording part that records the communicated content between a measuring subject whose skill in handling a cyber-attack is to be measured and the source of a simulated cyber-attack, and a skill measurement part that evaluates the skill of the measuring subject in handling a cyber-attack on the basis of whether or not the content of communication between the measuring subject and the simulated cyber-attack source includes signature indicating a predetermined search action.

10. A skill measurement method including:
recording a communicated content between a measuring subject whose skill in handling a cyber-attack is to be measured and a simulated cyber-attack source; and
evaluating the skill of the measuring subject in handling a cyber-attack on the basis of whether or not the communicated content between the measuring subject and the simulated cyber-attack source includes signature indicating a predetermined search action.

11. A simulated cyber-attack method including:
selecting a measuring subject from a measuring subject table that stores a plurality of measuring subjects whose security handling skill is to be measured and launching a predetermined simulated cyber-attack thereon; and
notifying a predetermined skill measurement apparatus of the selected measuring subject and a source IP address used in the simulated cyber-attack.

12.-13. (canceled)

14. The skill measurement method according to claim 10, including:
referring to a table that determines a score corresponding to each type of the search action and adding up scores of the search action taken by the measuring subject.

15. The skill measurement method according to claim 14, including:
referring to a second table for identifying the type of the search action taken by the measuring subject from a message included in the communication.

16. The skill measurement method according to claim 10, including:
transmitting predetermined simulated content to the measuring subject when the measuring subject requests content from the simulated cyber-attack source at a predetermined port number.

17. The skill measurement method according to claim 16, wherein the predetermined simulated content prompts the measuring subject to take a search action.

18. The skill measurement method according to claim 10, including:
receiving the measuring subject whose skill in handling the cyber-attack is to be measured and an IP address representing the simulated cyber-attack source from a predetermined simulated cyber-attack apparatus.

19. The simulated cyber-attack method according to claim 11, including:
selecting a source IP address used in the simulated cyber-attack from IP addresses prepared in advance and uses the selected IP address.
